(19) United States
(12) Patent Application Publication
(10) Pub. No.: US 2014/0121117 A1
(43) Pub. Date: May 1, 2014

(54) SAMPLE ANALYSIS BY MASS CYTOMETRY

(71) Applicant: DVS SCIENCES INC., MARKHAM (CA)

(72) Inventor: SCOTT TANNER, AURORA (CA)

(73) Assignee: DVS SCIENCES INC., MARKHAM (CA)

(21) Appl. No.: 14/060,054

(22) Filed: Oct. 22, 2013

Related U.S. Application Data
(60) Provisional application No. 61/719,065, filed on Oct. 26, 2012.

(51) Int. Cl. G01N 27/62

(52) U.S. Cl. CPC G01N 27/626
USPC 506/4; 506/22

(57) ABSTRACT

In a mass cytometer system, a tissue sample labeled with multiple metal tags is supported on an encoded substrate for distribution profile mapping by laser ablation. Groups of elemental ions from each plume generated by each laser pulse are detected by the mass cytometer and the data is mapped according to the encoded substrate. This configuration allows for the production of a 3-dimentional distribution profile of the multiple metal tags in the tissue sample.

### FIELD

This invention relates to apparatus and methods for sample analysis by mass cytometry.

### INTRODUCTION

An analytical technique using laser ablation inductively coupled plasma (ICP) mass spectrometry (LA-ICP-MS) can be applied to the imaging of metal ion distribution in biological tissues. Typically, laser ablation-ICP-mass spectrometry can be used to interrogate a tissue sample to detect and map trace element distribution. This technique, however, is limited to surface analysis incorporating 2-dimentional imaging of thin tissue samples.

### SUMMARY

In view of the foregoing and in accordance with the present teachings, each plume generated by each laser pulse can be ionized and detected distinctly as a function of the sample depth by a mass cytometer while an encoded substrate supporting the sample (sample support) can have a substrate coding configured to codified its position on the encoded substrate and to indicate when a laser pulse ablates through the sample. This system and technique allows for a quantitative distribution profile to be generated through the thickness of the sample and the mapping of a 3-dimentional image of the sample.

Another aspect of the teaching is a method for sample analysis by mass cytometry. The method includes providing a sample labeled with more than one elemental tag. Supporting the labeled sample with an encoded substrate where the encoded substrate is configured with a substrate coding. At least one laser pulse is directed onto a location of the sample to generate a discrete plume corresponding to each of the at least one laser pulse. Each discrete plume comprises at least one of the more than one elemental tag and the substrate coding. The discrete plumes are introduced into an inductively coupled plasma (ICP) where groups of elemental ions are generated such that each of the groups of elemental ions corresponds with at least one of each of the more than one elemental tag and the substrate coding. The method further comprises detecting each of the groups of elemental ions simultaneously for each of the discrete plume and then correlating the detected groups of elemental ions with the substrate coding by, for example, identifying the location of the more than one elemental tag as a function of the substrate coding.

Another aspect of the teaching is a mass cytometer system for sample analysis. The system has an encoded substrate for supporting the sample and the encoded substrate is configured with a substrate coding comprising an array of codified metal compositions. The system also has a laser ablation system configured to generate a plume from the sample and from the substrate coding. A mass cytometer comprising an ion source and ion detector is coupled to the encoded substrate through a defined total path.

Yet another aspect of the teaching is a sample support for laser ablation mass cytometry. The support has an encoded substrate with a surface for supporting the sample. The encoded substrate has a substrate coding, such as an array of codified transitional metal isotope compositions, arranged to codify the encoded substrate.

### BRIEF DESCRIPTION OF THE DRAWINGS

The skilled person in the art will understand that the drawings, described below, are for illustration purposes only. The drawings are not intended to limit the scope of the applicant's teachings in any way. In the accompany drawings, where like reference numerals indicate like parts:

FIG. 1 is a pictorial representation of the system and process according to one embodiment of the present teaching;

FIG. 2 is an expanded view of the encoded substrate according to an embodiment of FIG. 1;

FIG. 3 and FIG. 4 are pictorial representations of encoded substrates according to various embodiments of the present teaching;

FIG. 5 is a pictorial representation of an encoded substrate with various embodiments of the substrate coding according to the present teaching; and

FIG. 6 is a schematic view of an embodiment of the ICP ion source according to the present teaching.

### DESCRIPTION OF VARIOUS EMBODIMENTS

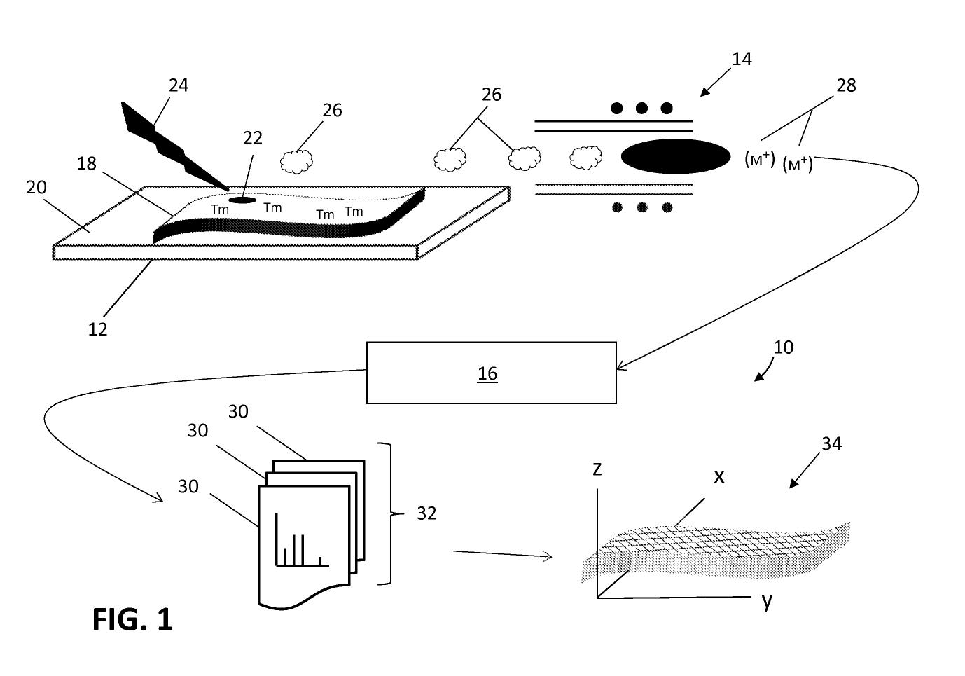

It should be understood that the phrase “a” or “an” used in conjunction with the present teachings with reference to various elements encompasses “one or more” or “at least one” unless the context clearly indicates otherwise. Reference is first made to FIG. 1, which shows a pictorial representation of the sample analysis system, generally indicated by reference number 10. The sample analysis system 10 comprises an encoded substrate 12 coupled to an inductively coupled plasma (ICP) ion source 14 of a mass cytometer 16. Generally, the ICP ion source 14 can be considered as an integral component of the mass cytometer 16, however for clarity, the ICP ion source 14 is represented separately from the mass cytometer 16. The mass cytometer 16 can comprise a computational system (not shown) for generating corresponding elemental tag data 30. The encoded substrate 12 provides a surface for supporting a sample 18 of interest while additionally being configured with a substrate coding 20 structure. The substrate coding 20 can provide a means for representing or mapping the spatial arrangement or distribution of a location 22 on the sample 18 during the analysis, as will be described below. The sample analysis system 10 further comprises a laser ablation system (not shown) for supplying at least one laser pulse 24 directed at the location 22 on the sample 18.

In use, the at least one laser pulse 24, upon being directed onto the surface of the sample 18, can remove some of the sample material in the form of a discrete plume 26. Generally, each laser pulse can generate a discrete plume 26 so that a series of laser pulses can generate a series of corresponding discrete plumes 26. In various embodiments, the sample 18 of interest can be labeled with more than one elemental tag Tn, typically selected from the group comprising transitional metals as described in co-pending U.S. patent application Ser. No. 12/513,011 published as US2010/0144056, assigned to the assignees of the present teachings. For convenience, the “n” notation in Tn can be a variable to signify the different elemental or metal isotope tag Tn. For example, a tissue sample containing cells of interest can be labeled with more than one type of metal conjugated antibody. The metal or elemental tag Tn conjugated to each type of antibody can be a distinct metal isotope of any one or a combination of Gd, Nd, Tb, Eu, Gd, Dy, Ho, Sm, Er, Yb, to name only a few. Consequently, the material removed from the location 22 of the sample 18 for each discrete plume 26 can contain the more than one elemental tag Tn—such as the combination of Nd and Sm for elemental tag “T1” and Gd, Tb and Er for elemental tag “T2”, for example.

While maintaining the spatial separation of each successive plume 26, each plume 26 can be transported and introduced into the ICP ion source 14 as discrete and independent entities. As each discrete plume 26 passes into the ICP ion source 14, each elemental tag Tn can be ionized into corresponding elemental ions quantitatively related to each elemental tag Tn. Since there can be more than one elemental tag Tn in the labeled sample 18, the ICP ion source 14 can generate a distinct group of elemental ions for each elemental tag Tn. Consequently, for each discrete plume 26, the ICP ion source 14 can generate groups of elemental ions 28, represented generally as (le) in FIG. 1. Each of the groups of elemental ions 28 can be detected by the mass cytometer 16 according to the ions' mass to charge ratio (m/z). In accordance with the present teachings, the mass cytometer 16 can detect each of the elemental ions simultaneously and, with its advantageous fast transit time, the mass cytometer 16 can differentiate between groups of elemental ions originating from successive lasers pulses. The elemental tag data 30, shown in FIG. 1 as a succession of single data files, represents the data acquired from simultaneously detecting the groups of elemental ions 28 for the succession of each plume 26. Hence, the sample analysis system 10 can detect and identify each of the more than one elemental tag Tn simultaneously for each laser pulse 24. While a single laser pulse can generate a plume containing the more than one elemental tag Tn, there can be some locations 22 on the sample 18 where a series of laser pulses 24 can be required to reach a certain sample depth before encountering the presence of the more than one elemental tag Tn. Furthermore, there can be instances where there can be an absence of any elemental tag Tn at a location 22 on the sample 18 and consequently the series of discrete plumes 26 contain no elemental tags Tn. In this instance, the absence of any elemental tag Tn can be interpreted to provide a source of information regarding other potential characteristics of interest. Accordingly, the applicants recognize that the information from each discrete plume can advantageously be used in combination with the substrate coding 20 to generate elemental tag profiles throughout the thickness of the sample 18 and to identify its location 22 with respect to the area of the sample 18, as will be described below.

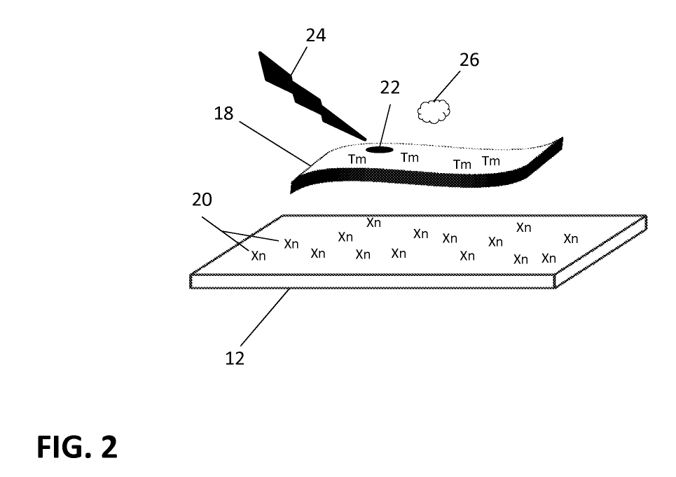

To help understand how the encoded substrate 12 can be structured for identifying and mapping out each location 22 on the sample 18, reference is now made to FIG. 2. For visual clarity, the sample 18 and the encoded substrate 12 are separated to show details of the substrate coding 20. The substrate coding 20 can have an array arrangement comprising differentiating metal compositions or alloys, generally denoted as Xn, codified at positions across the encoded substrate 12. For convenience, the “n” notation in Xn can be a variable to signify distinct and distinguishable compositions Xn. Thus, each position on the encoded substrate 12 can be represented and identified by its specific metal composition Xn. For brevity, the terms substrate coding 20 and the corresponding metal composition Xn, arranged for making up the coding, are used interchangeably for the present teachings. In various embodiments, for example, the substrate coding 20 can be an aggregate of transitional metal isotopes (as noted above) assembled in predetermined permutations and concentrations to achieve an array of unique identifiers. For distinguishability, the choice of the transitional metal isotopes used for each of the metal compositions Xn can be selected to be sufficiently distinct and distinguishable from the elemental tags Tn used for labeling a sample. Consequently, the position coordinates of each unique identifier on the encoded substrate 12 can be recorded for future cross reference and decoding as required.

The decoding process for detecting or identifying the unique identifiers can follow a similar technique as described above for releasing and detecting the elemental tag Tn from the labeled sample 18. Congruently, when at least one laser pulse 24 is directed at the encoded substrate 12, some of the substrate coding 20 can be removed and can be formed into the plume 26. The plume 26 comprising the released composition Xn can be directed to the ICP ion source 14 for ionization. Subsequently, the groups of elemental ions 28 generated by the ICP ion source 14 can be identified by the mass cytometer 10 as having their origins from the encoded substrate 12 and accordingly, determine its position by cross referencing the coordinate information associated with the substrate coding 20.

While in use, a sample 18 of interest can be supported by the encoded substrate 12 and the area, or layout, of the sample 18 can be represented by the underlying substrate coding 20 array. In some instances, the location 22 can be predetermined or selected by performing a pre visual analysis (such as florescence, phosphorescence, reflection, absorption, shape recognition or physical feature) of the labeled sample 18 to identify locations 22 expressing certain quality of interest. However, according to the present teachings, the location 22 of interest can be selected without a pre analysis of the labeled sample 18. In various embodiments, for example, the location 22 of interest can be based on a raster pattern, a structured sampling technique employing Monte Carlo methods for instance, or a basic random selection method. During the analysis, as each laser pulse 24 removes sequential layers of the labeled sample 18 from the location 22 of interest, groups of elemental ions 28 corresponding with the more than one elemental tag Tn can be simultaneously detected by the mass cytometer 16. Each of the detected groups of elemental ions 28 can represent the material removed at each layer of the sample 18. As noted above, some of the discrete plumes 26 can contain no elemental tag or some of the discrete plumes 26 can comprise a gradation of elemental tags. Furthermore, in various embodiments, some of the discrete plumes 26 can comprises overlapping information from each of the more than one elemental tag Tn. Thus, for each of the simultaneous detection performed by the mass cytometer 16, the data 30 can contain qualitative and quantitative information based on the presence and in some instances the absence, of the one or more elemental tag Tn. Each of the acquired data 30 can provide a piece of the information about the cross-section or thickness profile of the labeled sample 18.

As the analysis progresses and the successive laser pulses 24 penetrates through the thickness of the sample 18, at least one of the laser pulses 24 can remove or begin to remove some of the substrate coding 20. Accordingly, when the groups of elemental ions 28 detected by the mass cytometer 16 comprises the elemental ions from the metal composition Xn, the system 10 can determine that the laser has completed its ablation through the labeled sample 18. Thus, the elemental tag data 30 resulting from each of the previous laser ablations can be grouped together as a set 32 of data assigned to represent the information acquired at the location 22, and that the set 32 of data corresponds with the specific metal composition Xn on the encoded substrate 12. The system 10 can then codify the location 22 on the labeled sample 18 to correspond with the position of the detected substrate coding 20. By cross-referencing the detected groups of elemental ions 28 with the elemental tags Tn and correlating with the substrate coding 20, each of the elemental tags Tn and their location 22 on the sample 18 can be identified as a function of the substrate coding 20. Consequently, the set 32 of acquired elemental tag data 30 can be used to generate a distribution profile 34 corresponding with the thickness of the labeled sample 18 at its identified location 22. This process can be repeated, as necessary, for each subsequent location 22 on the labeled sample 18. Accordingly, and with the aid of an appropriate algorithm, the distribution profile 34 can be visualized to represent a 3-dimensional image of the elemental tag profile of the labeled sample 18.

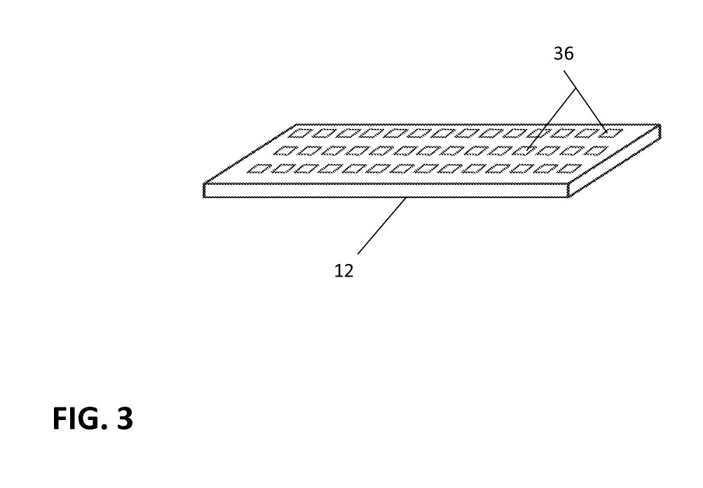

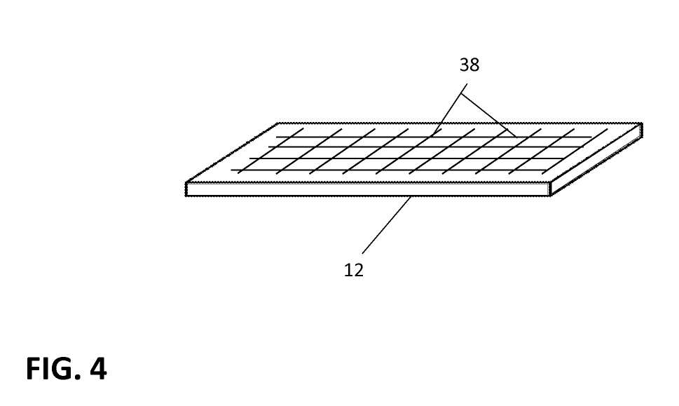

While the present teachings are described in conjunction with various embodiments, it is not intended that the present teachings be limited to such embodiments. On the contrary, the present teachings encompass various alternatives, modifications, and equivalents, as will be appreciated by those of skill in the art. For example, the present applicants recognize that the codified metal compositions Xn can be located on the surface of the encoded substrate 12, embedded in a sub-layer of the encoded substrate 12 or integrated in the thickness of the encoded substrate 12 as can be generally fabricated by such methods as molecular beam epitaxy or microfabrication using photolithography or similar techniques. Recesses 36 or etched grooves 38 (such as 100 μm deep wells) on the encoded substrate 12 can be used to provide receiving areas for each of the distinct metal compositions Xn, as shown in FIG. 3 and FIG. 4 respectively. The material for the construction of the encoded substrate 12 can be selected from any one or a combination of stainless steel, glass, quartz, ceramic, polytetrafluoroethylene (PTFE) and polyetheretherketone (PEEK) to name a few. While each metal composition Xn can be generally described as discrete substances detached or isolated from each other, the present applicants have contemplated that a trace or track of codified metal composition Xn in the form of a continuous deposit or coating can be used to provide unique identifiers. In various embodiments, for example, a continuous deposit can be applied to the encoded substrate 12 in such a manner as to provide a varying concentration gradient of more than one transition metal. The decoding process can be based on detecting the ratio of the metal concentration at a given location of the deposit. Accordingly, the analysis system 10 can be programmed with the deposit pattern and the corresponding metal concentration ratios for each encoded substrate 12. The encoding and decoding information can enable the correlation between the labeled sample 18 and the substrate coding 20 for identifying the location of the more than one elemental tag Tn with respect to the area of the labeled sample 18 as described above.

In various embodiments, the metal codified composition Xn can be further characterized as having luminescence properties. For example, the encoded substrate 12 can be made from a transparent material, such as glass, and the metal codified composition Xn can be a metal or non-metal fluorescent material (such as, for example, europium complexes or fluorophores respectively) codified on the surface, embedded in a sub-layer or integrated in the thickness of the encoded substrate 12. In use, as the laser pulses 24 penetrates through the thickness of the sample 18, at least one of the laser pulses 24 can illuminate the codified fluorescent material at the location 22 of the sample 18 and produce a distinguishable fluorescence emission spectra. With an appropriate optical detector positioned beneath the encoded substrate 12, for example, the detected emission spectra can be used as the detected substrate coding 20 for correlation as described above.

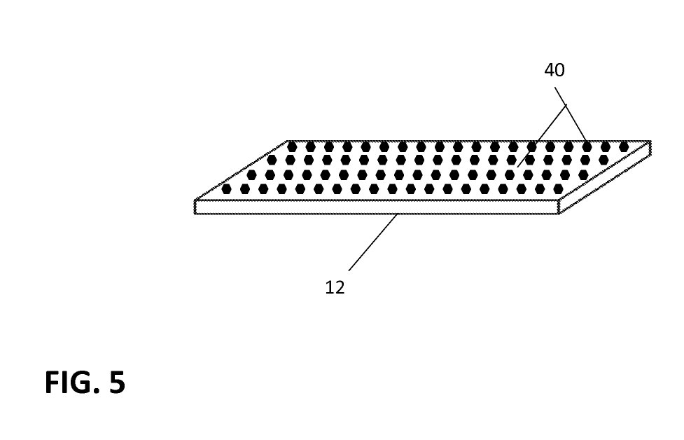

Alternatively, according to FIG. 5, the substrate coding 20 can be based on particles 40, such as beads, or other forms of carriers to which unique metal identifiers can be incorporated. In various embodiments, for example, the particles 40 can reside in the recesses 36 according to FIG. 3. The metal composition Xn can be attached on to the surface or imbedded within the carrier. The carriers can be arranged on the encoded substrate in an array pattern of a predetermined orientation, such as a grid formation, so that the carrier's position codifies the encoded substrate. In use, the energy from the at least one laser pulse can removed the metal composition Xn, along with or without the material of the carrier, into the formation of the discrete plume 26 as previously discussed.

In various embodiments the metal composition Xn can comprise a reference element (such as, for example, the element Rh or Ir or a combination thereof) for which the analysis system 10 can detect and use as a standard for system calibration. Alternatively, the reference element can be introduced to the sample in the form of a reference label. The label can be non-specifically attached to the sample 18 thus providing a reference standard throughout the sample.

The applicants of the present teachings recognizes that in order for each acquired elemental tag data 30 to correspond with each layer of the labeled sample 18, the spatial separation of each successive plume 26, and the corresponding ions, during their travel along the path between the encoded substrate into the ICP ion source 14 and between the ion source 14 and the ion detector (not shown) of the mass cytometer 16 is maintained. For example, a solid state laser typically used for laser ablation, such as a femtosecond pulsed laser can be configured to operate with a pulse rate between 10 and 100 Hz. At this frequency, a plume 26 can be generated every 10 to 100 msec. Considering the lower limit, it can be required to minimize the delay time within the system 10 to a level of the order of 10 msec in order to maintain plume separation. In accordance with various embodiments of the present teachings, the mass cytometer 16 can be characterized as a “flow-through” analytical device comprising a linear ion path with electrostatic lenses and an ion detector capable of parallel elemental ion detection. In this configuration, a delay time in the order of 10 msec can be achieved so that the groups of elemental ions (M⁺) can undergo acceleration and pass within the mass cytometer 16 for simultaneous detection. Consequently, the likelihood of the ion detector to separately detect each of the groups of elemental ions 28 can be realized.

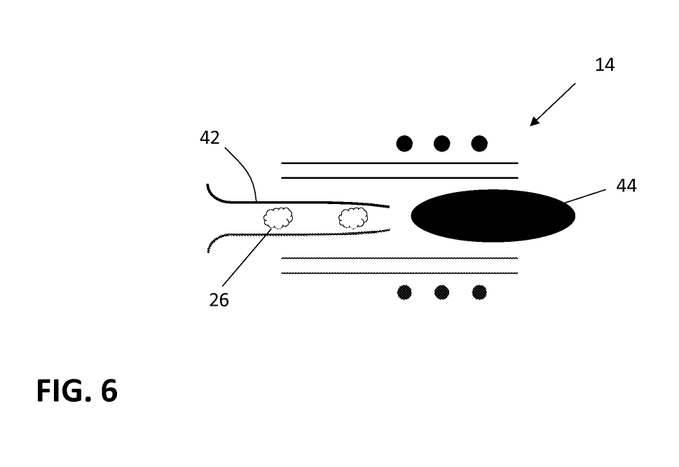

To maintain a corresponding spatial distinctiveness upstream of the mass cytometer 16, the configuration of the path between the laser ablation location, at the encoded substrate 12, and the entrance to the plasma can be chosen to maximize the plume 26 separation while minimizing flow turbulence. At the lower limit, a delay time of the order of 10 msec for maintaining the separation of each plume 26 before ionization can be achieved with the path having a minimum distance of plume travel and a corresponding means of accelerating the same. Generally, the ICP ion source 14 utilizes an injector tube 42, as indicated in FIG. 6, and a flow of carrier gas (not shown) can be applied appropriately to direct each discrete plume 26 into the plasma 44. Accordingly, the injector tube 42 can be configured to provide a laminar or near laminar flow geometry, having a Reynolds number below 2000 for instance, for receiving the plume 26 and for the carrier gas to flow with the plume 26 such that any turbulence can be minimized. Thus, in various embodiments, the combined delay time corresponding to the total path between the encoded substrate 20 and the ion source 14 and between the ion source 14 and the ion detector of the mass cytometer 16 can be between 20 msec and 200 msec.

Furthermore, in various embodiments, the encoded substrate 12 can be positioned relative to the ICP ion source 14 such that the travel time for each plume 26 can be minimized. For example, the ICP ion source 14 can be structured to encompass the encoded substrate 12 for providing a closely coupled laser-ablation-ICP ion source. The laser-ablation-ICP ion source can be configured with an integrated enclosure having an optical entrance for the laser pulses 24, a carrier gas for capturing and transporting the plume and the ICP ion source for generating the groups of elemental ions 28. The carrier gas flow (typically argon gas at 0.1 to 1 liter per minute for example) can be configured to sweep off each discrete plume 26 at the ablation location 22 and pass each plume 26 directly into the plasma 44.

While efforts have been described to create the conditions for maintaining the spatial separation of each plume 26 and the corresponding groups of elemental ions 28 throughout the sample analysis, the applicants of the present teachings recognizes that some spatial spreading or overlapping can be present. Accordingly, the applicants have contemplated combining the acquired elemental data 30 from two or more pulses 26 together to represent information for a “hybrid” layer of the labeled sample 18. The hybrid method can potentially produce a distribution profile 34 without significantly reducing its resolution. Alternatively, different forms of noise analysis algorithms, such as FFT, can be applied to the resulting set 32 of acquired elemental data 30 to achieve the necessary resolution for generating the desired distribution profile 34. The different forms of algorithms as mentioned above can be operated within the analysis system 10 or can be applied post data acquisition as is generally known.

While in various embodiments the term “sample” is generally in reference to thinly sectioned biological tissue samples, the present teachings can be equally applied to samples of greater thickness than generally practiced. In various embodiments, for example, in addition to sample sections of up to 100 micrometer thick produced by a typical sectioning instrument, tissue samples in the order of millimeters can be analyzed according to the present teachings. Under some circumstances, un-sectioned tissue sample blocks having bulk properties of interest can be accommodated for use with the present teaching.

1. A method of sample analysis by mass cytometry comprising:
providing a sample labeled with more than one elemental tag;
providing an encoded substrate for supporting the sample, the encoded substrate being configured with a substrate coding;
directing at least one laser pulse onto a location of the sample and generating a discrete plume for each of the at least one laser pulse, each of the discrete plume comprises at least one of the more than one elemental tag and the substrate coding;
introducing each of the discrete plume into an inductively coupled plasma and generating groups of elemental ions, each of the groups of elemental ions corresponding with at least one of each of the more than one elemental tag and the substrate coding;
detecting each of the groups of elemental ions simultaneously for each of the discrete plume;
correlating the detected groups of elemental ions with the substrate coding; and
identifying the more than one elemental tag as a function of the substrate coding.

2. The method according to claim 1 further comprising identifying the location of the more than one elemental tag as a function of the substrate coding.

3. The method according to claim 2 further comprising generating a distribution profile corresponding with the identified more than one elemental tag.

4. The method according to claim 3 in which the distribution profile is a 3-dimensional elemental tag profile of the sample.

5. The method according to claim 4 in which the substrate coding comprises metal compositions being arranged for representing positions on the encoded substrate.

6. The method according to claim 5 in which each of the discrete plumes contains the more than one elemental tag.

7. The method according to claim 6 further comprising introducing a reference element to the labeled sample.

8. The method according to claim 7 wherein the discrete plume further comprises the reference element such that at least one of the elemental ion groups corresponds with the reference element.

9. The method according to claim 8 wherein the location of the labeled sample is predetermined for having a property of interest.

10. The method according to claim 9 in which the property of interest is selected by one of a fluorescence, a phosphorescence, a reflection, an absorption, a shape recognition and a physical feature.

11. The method according to claim 10 in which the sample is a tissue sample.

12. The method according to claim 11 in which the at least one elemental tag is a transitional metal isotope.

13. A mass cytometer system for sample analysis comprising:
an encoded substrate for supporting a sample, the encoded substrate being configured with a substrate coding comprising an array of codified metal compositions;
a laser ablation system configured to generate a plume from the sample and from the substrate coding; and
a mass cytometer coupled to the encoded substrate for receiving the plume, the mass cytometer having an ion source to generate groups of elemental ions from the plume and an ion detector to detect the groups of elemental ions.

14. The mass cytometer system according to claim 13 further comprising a total path defined between the encoded substrate and the ion detector, the total path being configured to enable a combined delay time of between 20 and 200 msec.

15. The mass cytometer system according to claim 14 in which the codified metal compositions comprises an aggregate of transitional metal isotopes.

16. The mass cytometer system according to claim 15 in which the codified metal compositions are located on the surface of the encoded substrate.

17. The mass cytometer system according to claim 16 in which the codified metal compositions are recessed on the surface of the encoded substrate.

18. The mass cytometer system according to claim 13 in which the codified metal compositions comprises a metal or non-metal fluorescent material.

19. A sample support for laser ablation mass cytometry comprising an encoded substrate having a surface for supporting a sample of interest, the encoded substrate being configured with a substrate coding arranged to codify the encoded substrate.

20. The support according to claim 19 in which the substrate coding comprising an array of codified metal compositions.

21. The support according to claim 20 in which each of the codified metal compositions in the array being distinguishable according to their mass-to-charge ratios.

22. The support according to claim 21 in which the codified metal compositions comprises transitional metal isotopes.

23. The sample support according to claim 22 in which the transitional metal isotopes are recessed on the surface of the encoded substrate.

24. The sample support according to claim 22 in which the codified metal composition is fabricated by one of a molecular beam epitaxy and a photolithography.

25. The sample support according to claim 20 in which each of the codified metal compositions in the array being distinguishable according to their fluorescence emission spectra.
